(19) United States
(12) Patent Application Publication
(10) Pub. No.: US 2006/0222821 A1
(43) Pub. Date: Oct. 5, 2006

(54) Composite substrate, method of manufacturing the same, a thin film device, and method of manufacturing the same

(75) Inventor: Taku Masai, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/390,311

(22) Filed: Mar. 28, 2006

(30) Foreign Application Priority Data
Mar. 31, 2005 (JP) 2005-105273

(51) Int. Cl. B32B 1/00; B32B 15/00

(52) U.S. Cl. 428/174; 428/457; 428/692.1

(57) ABSTRACT

A composite substrate capable of suppressing a deformation of the substrate in response to the influence of internal stress of a conductive film is provided. When a conductive film is formed on a substrate, the conductive film is formed so as to have a laminated structure including a main conductive film which has a tensile stress FT as its internal stress F1 and a sub-conductive film which has a compressive stress FC as its internal stress F2. In this manner, the tensile stress FT of the main conductive film is offset by use of the compressive stress FC of the sub-conductive film. Thereby, unlike the case where the conductive film is formed so that only the main conductive film may be included without including the sub-conductive film, the substrate becomes less deformable in response to the influence of the internal stress F of the conductive film.

### BACKGROUND OF THE INVENTION

1. Field of the Invention

The present invention relates to a composite substrate including a substrate and a conductive film thereon, its manufacturing method, a thin film device to which the composite substrate is applied, and its manufacturing method.

2. Description of the Related Art

Composite structure objects (what is called a composite substrate) with a substrate and a conductive film thereon have been used widely in the thin film device field of a various application in recent years. One example of such thin film devices using the composite substrate includes a thin film inductor provided with a coil that works as the above-mentioned conductive film. This thin film inductor basically has a structure where the coil is provided on a supporting substrate.

In order to reduce the direct current resistance of the conductive film as for this composite substrate, it is requested that the thickness of the conductive film be set up largely. In accordance with this request, when a composite substrate is manufactured, an electrolytic plating method, which enables to make the film-thickness thicker with ease, is generally used as a film formation practice of the conductive film.

As for forming the conductive film using this electrolytic plating method, some techniques have already been proposed.

As for forming the conductive film using this electrolytic plating method, some techniques have already been proposed.

Specifically, there is known a technique where a seed film (Cu-sputtered film) as an electrode film (plating foundation film) is formed and then growing up a plated film using the seed film. As a result, a coil (Cu-plated layer) as a conductive film is formed. (For example, refer to Patent Document 1). In this case, in order to prevent an exfoliation of the coil, an exfoliation preventing film (Cr-sputtered film) is formed first and then the seed film is formed on the exfoliation preventing film.

[Patent Document 1] Japanese Laid-Open Patent Publication No. Hei 07-235014

Especially, as for a technique for forming a conductive film with controlling an internal stress using the electrolytic plating method, a technique is known that a conductive film is fabricated by adding an additive for stress control in a plating liquid, growing a plated film of an alloy (copper based alloy) which contains the additive, and thus the conductive film is formed (for example, refer to patent documents 2 and 3).

[Patent document 2] Japanese Laid-Open Patent Publication No. Hei 05-059468

[Patent document 3] Japanese Laid-Open Patent Publication No. Hei 11-335800

Further, though it is not the technique which forms a conductive film using the electrolytic plating method, as a technique for forming a conductive film with controlling the internal stress, there is known a technique that the internal stresses of the two conductive films are offset each other by forming a conductive film (ITO, indium tin oxide film) by low-temperature sputtering, then by forming another conductive film (ITO film) by high temperature sputtering (for example, refer to patent documents 4).

[Patent documents 4] Japanese Laid-Open Patent Publication No. Hei 07-43735

By the way, in order to establish a stable fabrication process of thin film devices to which the composite substrate is applied, it is necessary to fabricate thin film devices as with high quality as possible. However, in the conventional method of manufacturing a composite substrate, when a conductive film is formed so that it may obtain a desired large thickness using the electrolytic plating method, the substrate is easily deformed in response to the influence of the stress (what is called an internal stress) that is remaining inside the conductive film. Therefore, there lay a problem that it is difficult to fabricate a thin film device stably.

It is to be noted that the problem of deformation of substrates can be improved by using a series of the above-mentioned conventional technique. But use of those series of conventional technique may cause a new problem while the problem of deformation of substrates is solved. Specifically, in the case where a conductive film is formed by growing up a plated film by adding an additive for stress control in the plating liquid so that the plated film may be made of an alloy containing the additive, although it is possible to form the conductive film so that it may become a desired large thickness using the electrolytic plating method, if the resistance of the additive is stronger than the resistance of the conductive film, the resistance of the conductive film will go up owing to the presence of the additive. Besides, in the case where a conductive film is formed separately in accordance with the fabrication progress condition by both of low-temperature sputtering and high temperature sputtering, although it is possible to control the internal stress of the conductive film, it will become impossible to use the electrolytic plating method in forming the conductive film. In view of those, in order to realize a stable fabrication method of thin film devices to which the composite substrate is applied, it is desired that a technique capable of controlling deformation of a substrate in response to the influence of the internal stress of the conductive film is established, while using the electrolytic plating method in the formation practice of the conductive film and further controlling the rise of the resistance of the conductive film.

### SUMMARY OF THE INVENTION

The present invention is made in view of the foregoing problems and a first object of the invention is to provide a composite substrate which can suppress deformation of the substrate in response to the influence of the internal stress of the conductive film, or its manufacturing method.

A second object of the present invention is to provide a thin film device which can control deformation of the substrate in response to the influence of the internal stress of a coil, or its manufacturing method.

The composite substrate of the present invention has a substrate and a conductive film thereon which has a laminated structure containing a first conductive film with a tensile stress and a second conductive film with a compressive stress. The “tensile stress of the first conductive film” is a stress applied within the first conductive film from the outer side to the inner side thereof. On the other hand, the “compressive stress of the second conductive film” is a stress applied within the second conductive film from the inner side toward the outer side thereof. Namely, the internal stress of the second conductive film (compressive stress) works to the opposite direction of the internal stress of the first conductive film (tensile stress), thus relieving the internal stress of the whole conductive film by offsetting the internal stress of the first conductive film.

The thin film device of the present invention is provided with a first magnetic film, a second magnetic film, and a coil on a substrate, the coil being arranged between the first magnetic film and the second magnetic film, having a laminated structure including a first coil with a tensile stress and a second coil with a compressive stress.

The manufacturing method of the composite substrate of the present invention is a method of fabricating a composite substrate provided thereon with a conductive film which has a laminated structure. The manufacturing process of the conductive film includes a step of forming a first conductive film that composes a part of the conductive film so that it may have a tensile stress, and a step of forming a second conductive film that composes another part of the conductive film so that it may have a compressive stress.

A manufacturing method of a thin film device of the present invention is a method of manufacturing a thin film device which is comprised of a first magnetic film, a second magnetic film, and a coil having a laminated structure arranged between the first magnetic film and the second magnetic film, a fabrication process of the coil including a fabrication process of a first coil which composes a part of the coil so that it may have a tensile stress and a fabrication process of a second coil which composes another part of the coil so that it may have a compressive stress.

In the composite substrate of the present invention or its manufacturing method, when a conductive film having a laminated structure is formed on the substrate, the conductive film is formed so that it may include a first conductive film with a tensile stress and a second conductive film with a compressive stress. In this case, the tensile stress of the first conductive film is offset by use of the compressive stress of the second conductive film. Thereby, unlike the case where a conductive film is formed so that only the first conductive film may be included without including the second conductive film, it becomes difficult to deform the substrate in response to the influence of the internal stress of the conductive film.

In the thin film device of the present invention or its manufacturing method, when the coil which has a laminated structure is provided on the substrate, the coil is composed so that it may include a first coil with a tensile stress and a second coil with a compressive stress. In this case, the tensile stress of the first coil is offset by use of the compressive stress of the second coil. Therefore, unlike the case where the coil is formed so that it may include only the first coil without including the second coil, it becomes difficult to deform the coil in response to the influence of the internal stress of the coil.

In the composite substrate of the present invention, the first conductive film may be a plated film, and the second conductive film may be a sputtered film. In this case, sequentially from the side near the substrate, the conductive film may have: (1) a laminated structure where a first conductive film and a second conductive film are formed in this order; (2) a laminated structure where a first conductive film, a second conductive film, and again a first conductive film are formed in this order; (3) a laminated structure where a first conductive film and a second conductive film are formed in this order repeatedly; (4) a laminated structure where a second conductive film and a first conductive film are formed in this order; (5) a laminated structure where a second conductive film, a first conductive film and again a second conductive film are formed in this order; or (6) a laminated structure where a second conductive film and a first conductive film are formed in this order repeatedly.

Further, in the manufacturing method of the composite substrate of the present invention, the first conductive film may be formed by electrolytic plating, and the second conductive film may be formed by sputtering. In this case, film formation of the second conductive film is preferably conducted by adjusting the gas-pressure of the sputtering gas so that the second conductive film may have a compressive stress. Especially, it is preferred that the second conductive film is formed so that the thickness of the second conductive film may satisfy the following relational expression:
T2≧X*D*T1/[Y*(PS−P)]
(where “T1” is a thickness of the first conductive film, “T2” is a thickness of the second conductive film, “D” is a current density in the film formation of the first conductive film by electrolytic plating, “P” is a gas-pressure of the sputtering gas in the film formation of the second conductive film by sputtering, “PS” is a pressure specified based on the type of a sputtering gas and the type of a coating, a pressure used as the reference for producing a compressive stress inside the second conductive film (standard atmospheric pressure), “X” is a constant specified based on the bath conditions of the plating bath to be used in the electrolytic plating method, and “Y” represents a constant specified based on the type of the sputtering gas and the type of a coating, respectively.)

According to the composite substrate of the present invention or its manufacturing method, in the case where the substrate and the conductive film thereon which has a laminated structure are provided, the conductive film is formed so that it may include a first conductive film with a tensile stress and a second conductive film with a compressive stress. As a result, the tensile stress of the first conductive film is offset by use of the compressive stress of the second conductive film. In this manner, deformation of the substrate in response to the influence of the internal stress of the conductive film can be controlled.

According to the thin film device of the present invention or its manufacturing method, in the case where the substrate and the conductive film thereon which has a laminated structure are provided, the coil is formed so that it may include a first coil with a tensile stress and a second coil with a compressive stress. As a result, the tensile stress of the first coil is offset by use of the compressive stress of the second coil. In this manner, deformation of the substrate in response to the influence of the internal stress of the coil can be controlled.

### BRIEF DESCRIPTION OF THE DRAWINGS

FIG. 1 is a cross sectional view showing a cross sectional configuration of a composite substrate concerning one embodiment of the present invention.

FIG. 2 is a cross sectional view for explaining a manufacturing method of the composite substrate concerning one embodiment of the present invention.

FIG. 3 is a cross sectional view for explaining a fabrication process subsequent to FIG. 2.

FIG. 4 is a cross sectional view for explaining a fabrication process subsequent to FIG. 3.

FIG. 5 is a cross sectional view for explaining a fabrication process subsequent to FIG. 4.

FIG. 6 is a graph for explaining the principle by which the internal stress of a conductive film is controlled.

FIG. 7 is a cross sectional view for explaining a manufacturing method of a composite substrate as a comparative example compared with the composite substrate concerning one embodiment of the present invention.

FIG. 8 is a cross sectional view for explaining problems of the manufacturing method of the composite substrate described in the comparative example shown in FIG. 7

FIG. 9 is a cross sectional view representing a first modified example about a configuration of the composite substrate concerning one embodiment of the present invention.

FIG. 10 is a cross sectional view for explaining the manufacturing method of the composite substrate shown in FIG. 9.

FIG. 11 is a cross sectional view for explaining a fabrication process subsequent to FIG. 10.

FIG. 12 is a cross sectional view for explaining a fabrication process subsequent to FIG. 11.

FIG. 13 is a cross sectional view representing a second modified example about a configuration of the composite substrate concerning one embodiment of the present invention.

FIG. 14 is a cross sectional view representing a third modified example about a configuration of the composite substrate concerning one embodiment of the present invention.

FIG. 15 is a cross sectional view representing a fourth modified example about a configuration of the composite substrate concerning one embodiment of the present invention.

FIG. 16 is a cross sectional view representing a fifth modified example about a configuration of the composite substrate concerning one embodiment of the present invention.

FIG. 17 is a plan view showing a planar configuration of a thin film device to which the composite substrate concerning one embodiment of the present invention is applied.

FIG. 18 is a cross sectional view showing a cross sectional structure of the thin film device shown in FIG. 17 taken on line XVIII-XVIII.

FIG. 19 is a cross sectional view showing a first modified example of a configuration of the thin film device to which the composite substrate concerning one embodiment of the present invention is applied.

FIG. 20 is a cross sectional view showing a second modified example about a configuration of the thin film device to which the composite substrate concerning one embodiment of the present invention is applied.

FIG. 21 is a cross sectional view showing a third modified example about a configuration of the thin film device to which the composite substrate concerning one embodiment of the present invention is applied.

FIG. 22 is a cross sectional view showing a fourth modified example about a configuration of the thin film device to which the composite substrate concerning one embodiment of the present invention is applied.

FIG. 23 is a cross sectional view showing a fifth modified example about a configuration of the thin film device to which the composite substrate concerning one embodiment of the present invention is applied.

### DESCRIPTION OF THE PREFERRED EMBODIMENTS

The present invention will now be described in detail with reference to the drawings showing preferred embodiments thereof.

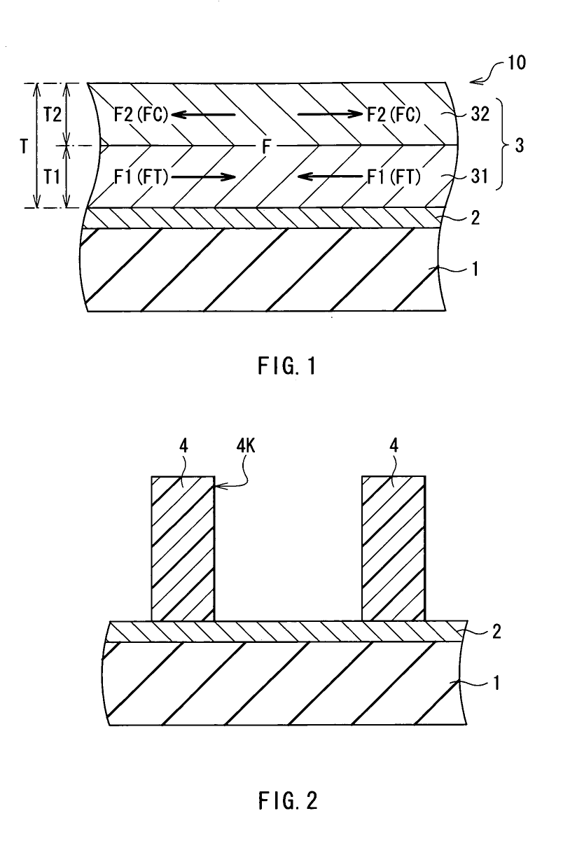

First, a composite substrate structure of one embodiment in the present invention will be described with reference to FIG. 1. FIG. 1 expresses a cross sectional configuration of a composite substrate 10.

The composite substrate 10 according to the embodiment is used in the thin film device field for various applications and, for example, applied to a thin film inductor, a thin film transformer, a thin film sensor, thin film resistance, a thin film actuator, a thin film magnetic head or MEMS (micro electro mechanical systems). The composite substrate 10 has a configuration that a conductive film 3 is formed on a substrate 1 as shown in FIG. 1. More specifically, the composite substrate 10 has a configuration that the conductive film 3 is formed on the substrate 1 via a seed film 2, namely, the seed film 2 and the conductive film 3 have been formed in this order on the substrate 1, for example.

The substrate 1 supports the composite substrate 10 as a whole. This substrate 1 is made of such materials as glass, silicon (Si), aluminum oxide (A1₂ O₃; what is called alumina), ceramics, semiconductor or resin, for example. It is to be noted that the component of the substrate 1 is not necessarily the above-mentioned series of materials but can be selected more freely.

The seed film 2 is an electrode film for growing up a plated film by electrolytic plating, and more specifically, it is used for forming a part of the conductive film 3 (an after-mentioned main conductive film 31) by electrolytic plating. Especially, the seed film 2 is provided between, for example, the substrate 1 and the conductive film 3 (the main conductive film 31) so that it may adjoin both of the substrate 1 and the conductive film 3, having a thickness of about 500 nm-1000 nm.

This seed film 2 is made of conductive materials, and configuration of the seed film 2 can be set up arbitrarily. Specifically, the seed film 2 may have a laminated structure including, for example: an adhesion layer made of titanium (Ti) and an electrode film made of copper (Cu) laminated in this order. Or, the seed film 2 may have a laminated structure including a nonproliferation layer made of chromium (Cr) and an electrode film made of copper laminated in this order. The “adhesion layer” has a function of sticking the electrode film to the substrate 1, and the “nonproliferation layer” has a high self-diffusion coefficient and has a function of preventing the component materials of the electrode film from spreading into the substrate 1. As a matter of course, the seed film 2 may have a laminated structure with configurations other than the above-mentioned laminated structure, or it may have a single layer structure.

The conductive film 3 is a substantial function part (for example an electrode section or a magnetic generation portion, etc.) in a thin film device to which the composite substrate 10 is applied, having an internal stress F. The conductive film 3 is configured with such conductive materials as copper (Cu), nickel (nickel), or silver (Ag) for example, having a thickness of T. Especially the conductive film 3 has a laminated structure in which a plurality of films are laminated, and more specifically, it includes a main conductive film 31 having an internal stress F1 and a sub-conductive film 32 having an internal stress F2.

The main conductive film 31 is a first conductive film that bears an original function equal to the conductive film 3, having a tensile stress FT as the stress F1, with thickness T1. This “tensile stress FT” is a stress which works inside the main conductive film 31 from the outer sides to the inner side as shown by the arrows appearing in FIG. 1, shrinking the main conductive film 31 itself and pulling the substrate 1 so that the substrate 1 may warp inwardly on the side of the conductive film 3. This main conductive film 31 is a plated film formed by electrolytic plating, for example, therefore it has the tensile stress FT as described above based on the process factor of the electrolytic plating method. The “process factor of the electrolytic plating method” is a factor on the process peculiar to the electrolytic plating method, wherein the tensile stress FT is produced inside the main conductive film 31 when the main conductive film 31 is formed by electrolytic plating. Incidentally, whether the internal stress F1 inside the main conductive film 31 is a tensile stress FT or not is discriminable by, for example, measuring the internal stress thereof by use of small-angle X-ray diffraction.

The sub-conductive film 32 is a second conductive film which bears an original function as the conductive film 3 like the main conductive film 31 and also bears another function of controlling the internal stress F inside the conductive film 3. It has a compressive stress FC as the internal stress F2, with a thickness of T2. Namely, the sub-conductive film 32 has a function of relaxing the internal stress F of the conductive film 3 (what is called stress relaxation) because it has the internal stress F2 (compressive stress FC) that counterbalances the internal stress F1 (tensile stress FT) of the main conductive film 31. This “compressive stress FC” is, as indicated by arrows appearing in FIG. 1, is a stress which works in the inside of the sub-conductive film 32 from the inner side to the outer side to extend the sub-conductive film 32 itself, compressing the substrate 1 so that the substrate 1 may warp outwardly on the side of the conductive film 3. This sub-conductive film 32 is a sputtered film formed by sputtering for example, having the compressive stress FC as described above on the basis of the process factor of the sputtering method. This “process factor of the sputtering method” is a factor on the process peculiar to the sputtering method by which the compressive stress FC is produced in the sub-conductive film 32 when the sub-conductive film 32 is formed by sputtering. Incidentally, whether the internal stress F2 inside the sub-conductive film 32 is a compressive stress FC or not is discriminable by, for example, measuring the internal stress thereof by use of small-angle X-ray diffraction in the same way as the case of identifying that the internal stress F1 of the main conductive film 31 is a tensile stress FT.

Here, as appearing in FIG. 1 the conductive film 3 has a laminated structure by which the main conductive film 31 and the sub-conductive film 32 are formed in this order from the side near the substrate 1. Namely, the main conductive film 31 is arranged on the seed film 2, and the sub-conductive film 32 is arranged on the main conductive film 31. As a result, the conductive film 3 has a laminated structure (two-layered structure) that includes the main conductive film 31 and the sub-conductive film 32.

It is to be noted that the conductive film 3 (the main conductive film 31/the sub-conductive film 32) may be a mode which covers the entire face of the seed film 2 (what is called a layer), for example, or it may be a mode selectively arranged in a predetermined pattern shape (planar shape) on the selected face of the seed film 2 (what is called a pattern).

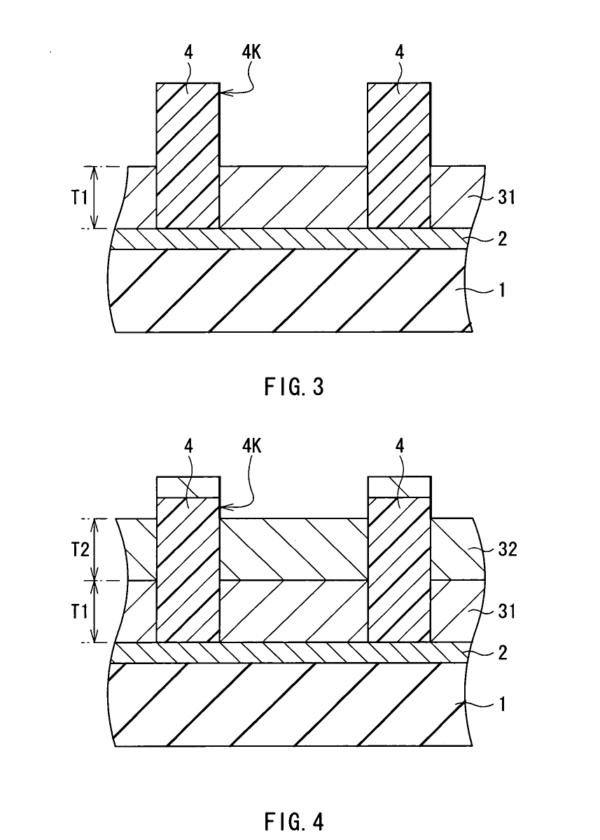

Next, with reference to FIGS. 1-6, a manufacturing method of the composite substrate 10 shown in FIG. 1 will be explained, as a manufacturing method of the composite substrate of the present embodiment. FIGS. 2-5 are drawings for explaining the method of fabricating the composite substrate 10, each showing the cross sectional configuration corresponding to FIG. 1. Moreover, FIG. 6 is for explaining the principle of controlling an internal stress F of the conductive film 3, where the “horizontal axis” expresses gas-pressure P (Pa) of sputtering gas, and the “vertical axis” expresses the internal stress F2 (MPa) of the sub-conductive film 32. Hereinafter, in the fabrication process of the composite substrate 10, for example, the case where the conductive film 3 is formed into a predetermined pattern shape will be explained. In that case, since quality, thickness, etc. of the series of the component elements which form the composite substrate 10 have been already explained in detail, those descriptions shall be omitted on occasion.

In manufacturing the composite substrate 10, the substrate 1 is prepared first as shown in FIG. 2 and then the seed film 2 is formed on the substrate 1 as an electrode film for growing up a plated film by electrolytic plating. As for the formation technique of the seed film 2, a sputtering method, electroless plating method, etc. are used, for example.

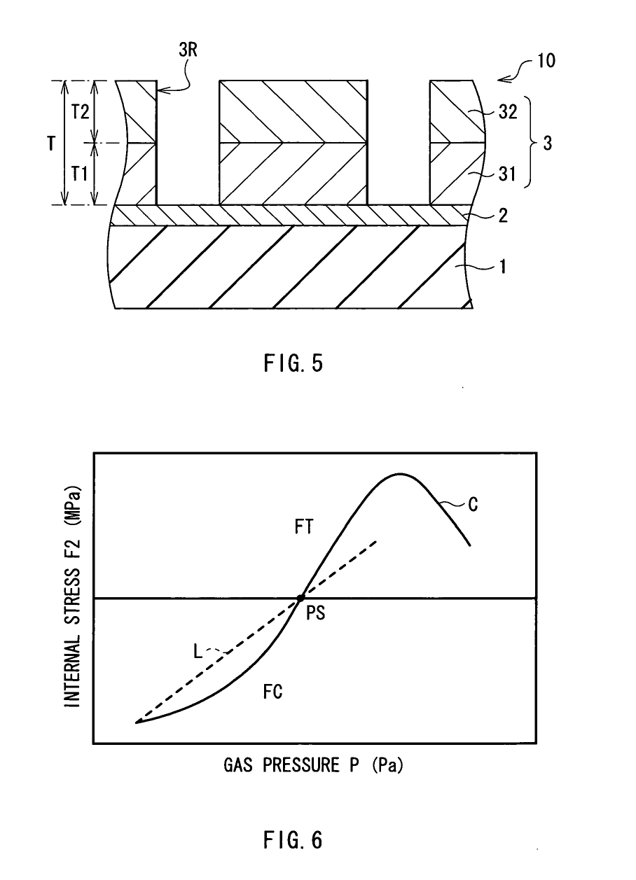

Then, photoresist is applied to the face of the seed film 2 to form a photoresist membrane (not shown). And then, the photoresist membrane is patterned (exposing and developing negatives) using a photo lithography process. As a result, a photoresist pattern 4 is formed on the seed film 2. In forming the photoresist pattern 4, the photoresist pattern 4 is selectively formed in the part where the conductive film 3 (refer to FIG. 5) is not formed in the post-process so that an opening 4K may be formed in the part where the conductive film 3 is to be formed, and the opening shape of the opening 4K may correspond to the pattern shape of the conductive film 3. Incidentally, as for the kind of photoresist, any kind of resist is allowable as far as it can conduct patterning by use of photolithography process. For example, a liquid resist which is widely used in the semiconductor process in general may be used, or a film resist may be used.

Then, after washing the face of the seed film 2 as necessary (for example, acid cleaning or ultraviolet (UV;ul) cleaning, etc.), a plated film is grown up on the seed film 2 as an electrode film by electrolytic plating. As a result, the main conductive film 31 which is a part of the conductive film 3 is selectively formed on the seed film 2 so as to correspond to the range of the opening 4K of the photoresist pattern 4, with a thickness of T1 as shown in FIG. 3. The plating bath used in order to form the main conductive film 31 by electrolytic plating can be arbitrarily selected depending on the component material of the main conductive film 31. For example, in the case of using copper (copper-plated film) as the component material of the main conductive film 31, a copper sulfate plating bath is used. In this case, based on the process factor in which the main conductive film 31 is formed by electrolytic plating, as appearing in FIG. 1, the main conductive film 31 will have a tensile stress FT as the internal stress F1.

Then, as shown in FIG. 4, by use of the sputtering method, the conductive film 32, which constitutes the other part of the conductive film 3, is formed with a thickness of T2 so that it may cover the photoresist pattern 4 and the main conductive film 31 surrounding the photoresist pattern 4. In this case, while the sub-conductive film 32 is formed on the main conductive film 31 in the opening 4K of the photoresist pattern 4, the sub-conductive film 32 is formed also on the photoresist pattern 4. Further, based on the process factor of forming the sub-conductive film 32 by sputtering, as shown in FIG. 1, the sub-conductive film 32 will obtain a compressive stress FC as the compressive stress F2. In this case, as described later, the sub-conductive film 32 is formed by adjusting the gas pressure of the sputtering gas so that the sub-conductive film 32 may obtain a compressive stress FC. Incidentally, after completing the composite substrate 10 by forming the conductive film 3 in the post-process, if you have a further purpose of forming other films with high quality upon the conductive film 3 (base) and thus you want to make the face of the base film (namely, the face of the conductive film 3) as much flat as possible, it is preferred to form the sub-conductive film 32 planarizing the membrane surface thereof by using, for example, a bias-sputtering method, which is a method of conducting a sputtered film formation on applying bias to the substrate 1.

Finally, the photoresist pattern 4 is removed, namely, the photoresist pattern 4 as well as the part of the sub-conductive film 32 formed on the photoresist pattern 4 (needless portion) are removed together. As a result of the above-mentioned process, as shown in FIG. 5, the sub-conductive film 32 is separated in accordance with the main conductive film 31. Thereby, the conductive film 3 is formed having a laminated structure which includes the main conductive film 31 and the sub-conductive film 32. In this case, the seed film 2 is partially exposed where the photoresist pattern 4 was arranged. Namely, a trench 3R is provided in the part where the photoresist pattern 4 was arranged. Thereby, a plurality of conductive films 3 (the main conductive films 31/the sub-conductive films 32) are formed in accordance with the pattern shape as separated by the trench 3R. In this manner, the composite substrate 10 has been completed.

Especially when manufacturing the composite substrate 10 through the above-described procedure, in the formation process of the sub-conductive film 32, the thickness T2 of the sub-conductive film 32 is set up in accordance with the following principles so that the internal stress F can be controlled by generating a stress relaxation phenomenon inside the conductive film 3, which is realized by offsetting the internal stress F1 (tensile stress FT) of the main conductive film 31 against the internal stress F2 (compressive stress FC) of the sub-conductive film 32.

Accordingly, when forming the sub-conductive film 32 by sputtering, there is a relation effected between the internal stress F2 of the sub-conductive film 32 and the gas-pressure P of the sputtering gas as shown in FIG. 6: the relation is that, the type of the internal stress F2 (a tensile stress FT or a compressive stress FC) of the internal stress F2 changes depending on the gas-pressure P. More specifically, when the gas-pressure P increases, the internal stress F2 increases rapidly in accordance with the increase of the gas-pressure P and then decreases, drawing a C-curve line as shown in the graph. Namely, the internal stress F2 becomes a compressive stress FC in the range where the gas-pressure P is lower than the specific pressure (reference gas pressure PS)(P<PS). On the other hand, the internal stress F2 becomes a tensile stress FT in the range where the gas-pressure P is higher than the reference gas pressure PS (P>PS). This reference gas pressure PS is a characteristic value specified on the basis of a type of the sputtering gas and a type of the plating, namely, it is a pressure used as the reference applied in adjusting the gas-pressure P in order to produce a compressive stress FC inside of the sub-conductive film 32. As known from the above, if the main conductive film 31 has a tensile stress FT as the internal stress F1 based on the process factor by use of an electrolytic plating method, in order to have the sub-conductive film 32 obtain the counterbalancing compressive stress FC as the internal stress F2 based on the process factor by use of a sputtering method, what is necessary is just to set up the gas-pressure P applied in forming the sub-conductive film 32 by sputtering so that the gas-pressure P may become lower than the reference gas pressure PS (P<PS), as is clear from the relationship between the internal stress F2 and the gas-pressure P shown with reference to FIG. 6.

Here, based on the above-mentioned setting range (P<PS) of the gas-pressure P, if the main portion of the curve C (the portion where the internal stress F2 is the compressive stress FC) which represents the correlation between the internal stress F2 and the gas-pressure P is approximated as a straight line L as shown in FIG. 6, The internal stress F1 of the main conductive film 31 and the internal stress F2 of the sub-conductive film 32 are expressed with the following relational expressions (1) and (2), respectively. That is, let the current density at the time of forming the main conductive film 31 by electrolytic plating be “D” (A/dm2), the internal stress F1 (MPa) of the main conductive film 31, which is a plated film, is expressed as a function of the current density D as shown by the relational expression (1). “X” is a constant specified based on the bath conditions of the plating bath used in the electrolytic plating method. Examples of the bath conditions for the plating bath specifying the value of “X” include a flow rate, temperature, etc. of the plating bath. On the other hand, the gas-pressure of the sputtering gas applied in forming the sub-conductive film 32 by sputtering is P, and a pressure (reference pressure) that becomes a reference for producing a compressive stress FC inside the sub-conductive film 32 is PS. Therefore, the internal stress F2 (MPa) of the sub-conductive film 32 which is a sputtered film is expressed as a function of the gas-pressure P, as shown in the relational expression (2). Incidentally, “Y” in the relational expression (2) is a constant specified based on the type of the sputtering gas and the type of the plating.
F1=X*D (1)
F2=−Y*(P−PS) (2)

In the case where the above-mentioned relational expression (1) and (2) are effected when the thickness to be made in forming the main conductive film 31 by electrolytic plating is T1 (μm) and the thickness to be made in forming the sub-conductive film 32 by sputtering is T2 (μm), in order to offset the internal stress F1 (tensile stress FT) of the main conductive film 31 against the internal stress F2 (compressive stress FC) of the sub-conductive film 32, taking it into consideration that the power of the internal stresses F1, F2 are proportional to the thickness T1 and T2 respectively, it is necessary that the product of the values of the internal stress F1 and the thickness T1 should be below the product of the values of the internal stress F2 and the thickness T2 as shown in the following relational expression (3). Therefore, when the thickness T2 of the sub-conductive film 32 is specified by substituting the relational expression (1) and (2) described above into the relational expression (3), in order to form the sub-conductivity 32, it is necessary to make the thickness T2 satisfy the relationship of the following relational expression (4). Incidentally, when substituting the relational expressions (1) and (2) into the relational expression (3) for deducing a relational expression (4), the relational expression (1) was substituted as it was without changing the sign in consideration of the internal stress F1 always serving as a positive value, while the relational expression (2) was substituted with changing the sign in consideration of the internal stress F2 serving as a negative value in the range of the gas-pressure P lower than the reference gas-pressure PS. Namely, the internal stress F1 (tensile stress FT) of the main conductive film 31 is set off using the internal stress F2 (compressive stress FC) of the sub-conductive film 32, by forming the sub-conductive film 32 so that the thickness T2 may satisfy the relationship of the relational expression (4). In this manner, the internal stress F of the conductive film 3 becomes controllable.
F1*T1≦F2*T2 (namely, F1*T1/F2*T2≦1.0) (3)
T2≧X*D*T1/[Y*(PS−P)] (4)

As a specific example, when using argon gas as a sputtering gas and growing up a copper-plated film using a copper sulfate plating bath as a plating bath, the values of “PS”, “X”, and “Y” in the above-mentioned relational expression (4) are PS=0.7, X=0.9, and Y=200, respectively. That is, the relational expression (4) is expressed like in the following relational expression (5). In this case, letting the current density D=2.0 A/dm², the thickness T1 of the main conductive film 31=10 μm, and the gas pressure P=0.1 Pa, for example, in order to control the internal stress F of the conductive film 3, the thickness of the sub-conductive film 32 should be T2=0.15 μm or more.
T2≧0.9*D*T1/[200*(0.7−P)] (5)
In the composite substrate or its manufacturing method of the present embodiment, when the conductive film 3 is formed on the substrate 1, since the conductive film 3 is formed so that it may include the main conductive film 31 which has a tensile stress FT as an internal stress F1 and the sub-conductive film 32 which has a compressive stress FC as an internal stress F2. Thereby, it can restrain the substrate 1 from deforming in response to the influence of the internal stress F in the conductive film 3 because of the following reasons.

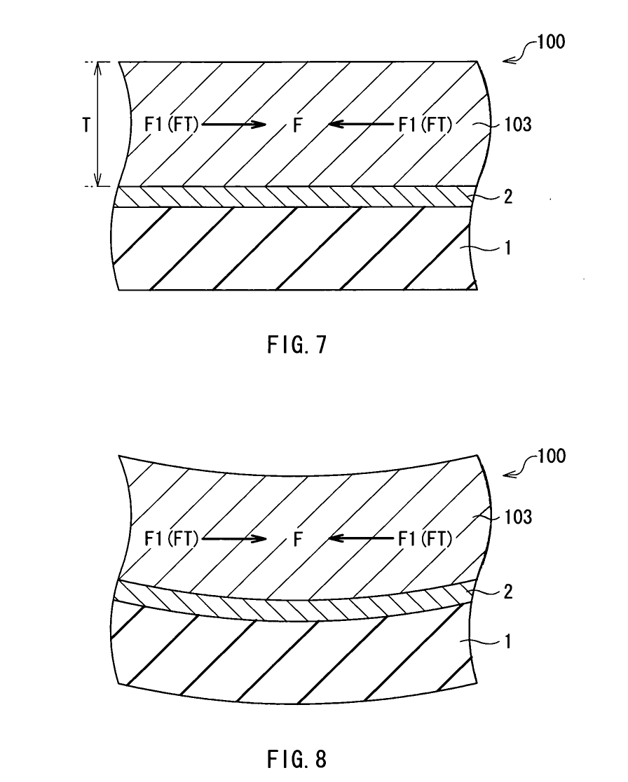

FIG. 7 is for explaining the manufacturing method of a composite substrate as a comparative example in comparison to the manufacturing method of the composite substrate of the present embodiment, representing a cross sectional configuration of a composite substrate 100 corresponding to the composite substrate 10 appearing in FIG. 1. FIG. 8 is for explaining a problem of the manufacturing method of the composite substrate in the comparative example appearing in FIG. 7, which represents a cross sectional configuration corresponding to FIG. 7. The manufacturing method of the composite substrate of the comparative example is different from the manufacturing method of the composite substrate of the present embodiment where the conductive film 3 (with a thickness of T=T1+T2) is made as a two-layered structure by forming a main conductive film 31 (thickness T1) by electrolytic plating and then forming a sub-conductive film 32 (thickness T2) on the main conductive film 31 by sputtering so that the conductive film 3 may have a laminated structure including the above-mentioned main conductive film 31 and the sub-conductive film 32. It passes through the same procedure as the manufacturing method of the composite substrate of the present embodiment except for the point that a conductive film 103 (thickness T) is formed in a lump so as to obtain a single-layered structure by electrolytic plating instead of the conductive film 3.

As shown in FIG. 7 with the manufacturing method of the composite substrate of the comparative example, since the conductive film 103 is formed in a lump by electrolytic plating, the conductive film 103 will have a tensile stress FT all over the film as its internal stress F1 on the basis of the process factor of the electrolytic plating method. In this case, since the internal stress F of the conductive film 103 is naturally controlled by the tensile stress FT, when the tensile stress FT becomes larger than the dynamic durability (rigidity) of the substrate 1, the substrate 1 will be deformed in response to the influence of the internal stress F (tensile stress FT) of the conductive film 103 as shown in FIG. 8. More specifically, the substrate 1 will be warped inwardly on the side of the conductive film 103 (concave on the side of the conductive film 103). If the substrate 1 is deformed, the conductive film 103 may be distorted or exfoliate easily owing to the deformation. The smaller the thickness of the substrate 1 is, the more notable becomes the tendency that the substrate 1 is easily deformed by the influence of the internal stress F (tensile stress FT) of the conductive film 103.

On the other hand, in the manufacturing method of the composite substrate of the present embodiment appearing in FIG. 1, the conductive film 3 is separately formed in two steps, namely, the main conductive film 31 is formed by electrolytic plating while the sub-conductive film 32 is formed by sputtering. Especially, since the sub-conductive film 32 is formed on the gas-pressure condition by which the internal stress F2 of the sub-conductive film 32 will counterbalance the internal stress F1 of the main conductive film 31 (that is, the gas-pressure P<reference gas pressure PS), the main conductive film 31 obtains a tensile stress FT as the internal stress F1 based on the process factor of using the electrolytic plating method while the sub-conductivity 32 obtains the compressive stress FC based on the process factor of using the sputtering method. In this case, since the internal stress F of the conductive film 3 is determined based on the sum total of the internal stress F1 (tensile stress FT) of the conductive film 31 and the internal stress F2 (compressive stress FC) of the sub-conductive film 32, the internal stress F of the conductive film 3 is determined so that the tensile stress FT of the main conductive film 31 is counterbalanced with the compressive stress FC of the sub-conductive film 32 If the thickness T2 of the sub-conductive film 32 is set up so as to satisfy the reference of the above-mentioned relational expression (4). Thereby, unlike the case of the manufacturing method of the composite substrate shown in the comparative example, it becomes difficult to deform the substrate 1 in response to the influence of the internal stress F of the conductive film 3. As a result, it can restrain an easy occurence of distortion or exfoliation of the conductive film 3 caused by the deformation of the conductive film 3. Therefore, the deformation of the substrate 1 caused by the influence of the internal stress F of the conductive film 3 can be controlled.

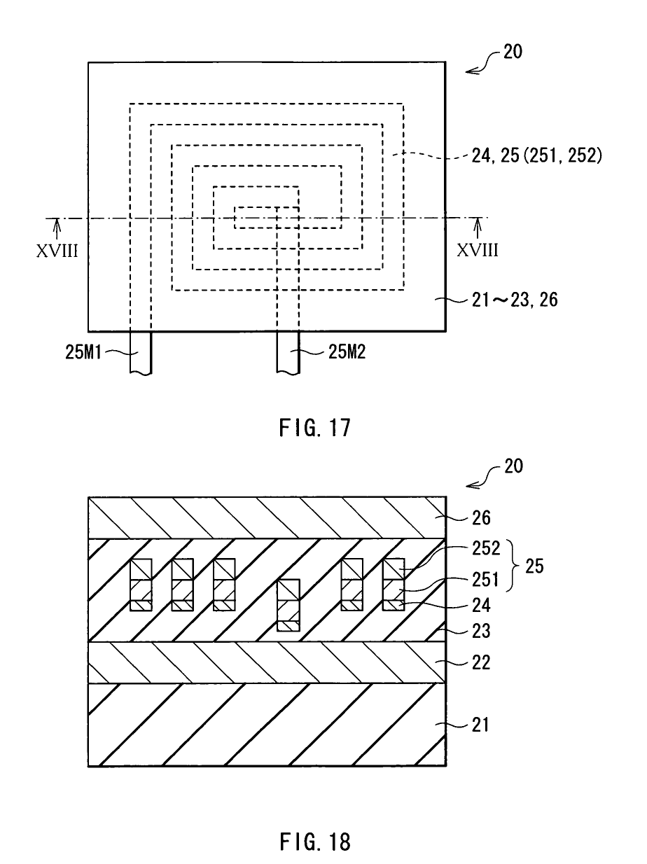

In particular, in the present embodiment, the internal stress F of the conductive film 3 is determined so that the tensile stress FT of the conductive film 31 can be offset against the compressive stress FC of the sub-conductive film 32 as described above. Thereby, the internal stress F of the conductive film 3 becomes small enough, which can contribute to the performance reservation of a thin film device to which the composite substrate 10 is applied. Specifically, when a composite substrate 10 is applied to a thin film device, such as a below-mentioned film inductor (refer to FIGS. 17-23) for example, one or more magnetic films are provided via an insulating film on the composite substrate 10 (the conductive film 3). In this kind of thin film devices, however, if the internal stress F of the conductive film 3 is not small enough, even though the substrate 1 is not deformed in response to the influence of the internal stress F, the magnetic films are easily distorted in a microscopic view. If the magnetic films are distorted, a coercive force increases and permeability decreases owing to the distortion in the magnetic domain structure, that is, the magnetic properties of magnetic films deteriorate. As a result, a bad influence is given to the performance of a thin film device. In view of this point, in the present embodiment, the internal stress F of the conductive film 3 becomes small enough so that the substrate 1 may not be deformed and the magnetic film may not be microscopically distorted easily. As a result, the magnetic properties of the magnetic film are maintained without deterioration. Therefore, it can contribute to the reservation of performance of thin film devices.

Besides, in the present embodiment, as shown in FIG. 1, since the conductive film 3 has been formed so that the sub-conductive film 32 may be provided on the main conductive film 31, the sub-conductive film 32 formed by sputtering serves as the top layer of the composite substrate 10. In this case, based on the process feature of the sputtering method, the film surface of the sub-conductive film 32 which is the top layer is made flat, and more specifically, the surface roughness (arithmetic average roughness) Ra of the film surface becomes small to the level of 1 nm-2 nm. As compared with this, in the case of the comparative example (refer to FIG. 7) in which the conductive film 103 formed by electrolytic plating method serves as the top layer of the composite substrate 100, the membrane surface of the conductive film 103 which is the top layer is difficult to be made flat owing to the process factor of the electrolytic plating method. More specifically, the surface roughness Ra of the film surface becomes larger to the level of 10 nm-20 nm. Therefore, in the present embodiment, since the top surface of the composite substrate 10 (the sub-conductive film 32) is made flat as compared with the case of the comparative example, based on the surface smoothness of the top film, it contributes to the quality reservation of thin film devices to which the composite substrate 10 is applied. As a specific example, in the case where the composite substrate 10 is applied to an after-mentioned thin film inductor (refer to FIGS. 17-23), the magnetic film is formed flatly, namely, the magnetic film is made in a uniform thickness due to the surface smoothness on the surface of the top surface of the composite substrate 10 (sub-conductive film 32). As a result, it can contribute to the quality reservation of the thin film devices.

It is to be noted that, in the present embodiment, in order to offset the internal stress F1 (tensile stress FT) of the main conductive film 31 by use of the internal stress F2 (compressive stress FC) of the sub-conductive film 32, as for the relation between the product of the internal stress F1 and the thickness T1 and the product of the internal stress F2 and the thickness T2, as shown in the above-mentioned relational expression (3), it is set up so that the ratio of the product of the internal stress F1 and the thickness T1 to the product of the internal stress F2 and the thickness T2 (hereinafter simply referred to as “product ratio”) may be 1.0 or less (F1*T1/F2*T2≧1). However, it is not necessarily limited to this, the setting range of the product ratio may be wider as far as the internal stress F of the conductive film 3 is controllable. As a specific example, when controlling the internal stress F of the conductive film 3 in order to prevent the substrate 1 from curving inwardly on the side of the conductive film 3 because the internal stress F1 (tensile stress FT) is too larger than the internal stress F2 (compressive stress FC), and in order to prevent the substrate 1 from curving outwardly on the side of the conductive film 3 (reverse warpage) because the internal stress F1 (tensile stress FT) is too small than the internal stress F2 (compressive stress FC) on the contrary, it is possible to give a ±20% range to the product ratio. That is, supposing what is necessary is that the product ratio should satisfy the following relational expression (6), it becomes possible to specify the range of the thickness T2 of the sub-conductive film 32 based on the relational expression (6). Herein, the relational expression (6) can be expressed as the following relational expression (7) based on the above-described relational expressions (1), (2) and (5). Therefore, for example, let a current density D=2.0 A/dm², a thickness T1=10 μm, and a gas-pressure P=0.3 Pa, in order to control the internal stress F of the conductive film 3 so that the warpage or reverse warpage of the substrate 1 can be controlled, what is necessary is just to set up the thickness T2 as: 0.18750 μm≧T2≧0.28125 μm.
0.8≧F1*T1/F2*T2≧1.2 (6)
0.8≧0.9*D*T1/[200*(0.7−P)]*T2≧1.2 (7)

For reference, the reason for giving a ±20% margin in the product ratio as shown in the relational expression (6) is as follows:

That is, when a substrate 1 which has a circle configuration is used for example,

let Young's modulus of the substrate 1 be E (Pa), thickness be H (m), radius be R (m), a Poisson's ratio be γ (−), and the amount of warpage (the amount of deflection) be δ (μm), the internal stress S (Pa·m) of the substrate 1 is expressed as shown in the following relational expression (8). Here, when a glass substrate is used as the substrate 1 for example, since E=7*10¹⁰ Pa, H=1*10⁻³ m, R=75*10⁻³ m, and γ=0.3,

in order to hold down the amount of warpage δ of the substrate 1 to the level of 25 μm or less in consideration of preventing such inconvenience as an adhesion phenomenon of the substrate 1 in the process where the composite substrate 10 is applied to thin film devices,

it is deduced that the internal stress S of the substrate 1 should be below 345 Pa·m on the basis of the relational expression (8). At this time, if the current density D is D=2 A/dm², the thickness T1 of the main conductive film 31 is T1=10 μm, the internal stress F1 of the main conductive film 31 is calculated like F1=1800 Pa·m based on the above-described relational expression (1). As a result, it is estimated that the stress which gives an influence to the substrate 1 is necessary to be set in the level of 345 Pa/1800 Pa≈about 20%, or less. Therefore, as described above, a margin of ±20% is provided in the product ratio.
S=E*H²*δ/[3*R²*(1−γ)] (8)

In the present embodiment, as explained with reference to FIG. 6, when forming the sub-conductive film 32 by sputtering, the gas-pressure P is set up uniformly (P<PS) so that the internal stress F2 of the sub-conductive film 32 may be a compressive stress FC. However, it is not necessarily limited to this, and the gas-pressure P can be changed so that the internal stress F2 may serve as both of a compressive stress FC and a tensile stress FT. Specifically, for example, in the film formation of the sub-conductive film 32 by sputtering, the gas-pressure P is controlled (P>PS) so that the internal stress F2 of the sub-conductive film 32 may become a tensile stress FT in the initial stage of the film formation, and in the middle of the film formation thereof, the gas-pressure P is re-set (P<PS) so that the internal stress F2 of the sub-conductive film 32 may turn into a compressive stress FC. In this manner, the internal stress F2 can be switched from the tensile stress FT to the compressive stress FC. In this case, when the sub-conductive film 32 is formed on the main conductive film 31 having a tensile stress FT as its internal stress F1, the sub-conductive film 32 obtains a tensile stress FT as its internal stress F2 just partially near the interface where the sub-conductive film 32 adjoins the main conductive film 31. Thereby the internal stress F1 of the main conductive film 31 and the internal stress F2 of the sub-conductive film 32 are matched dynamically because both of them come to have a tensile stress FT near the interface thereof. Thereby, compared with the above-mentioned embodiment where the internal stress F1 of the main conductive film 31 and the internal stress F2 of the sub-conductive film 32 are not matched dynamically because the sub-conductive film 32 has a compressive stress FC as its internal stress F1 near the interface adjoining the main conductive film 31, an occurrence of dynamic strain in the vicinity of the interface between the main conductive film 31 and the sub-conductive film 32 can be restrained. As a result, since dynamic equilibrium is secured between the internal stress F1 and the internal stress F2, the internal stress F of the conductive film 3 can be stabilized.

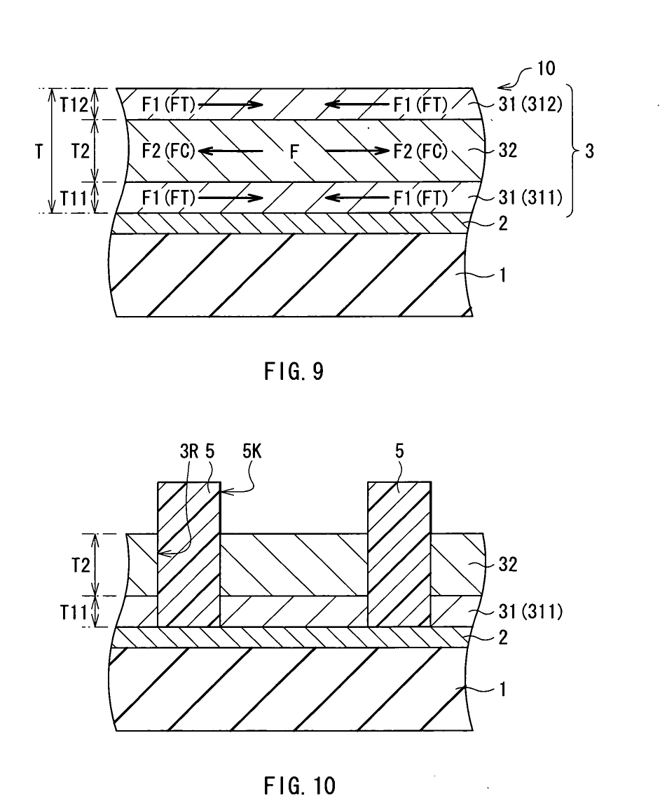

Moreover, in the present embodiment as shown in FIG. 1, the conductive film 3 has been fabricated to have a laminated structure (two-layered structure) where the main conductive film 31 and the sub-conductive film 32 are laminated in this order from the side near substrate 1. However, it is not necessarily limited to this, and as described above, as far as it is possible to control the deformation of the substrate 1 in response to the influence of the internal stress F of the conductive film 3 by offsetting the tensile stress FT of the main conductive film 31 against the compressive stress FC of the sub-conductive film 32, the configuration of the conductive film 3 can be changed freely as explained successively in the following as first to fifth modified examples (refer to FIGS. 9-16).

It is to be noted that the configurations of the composite substrate 10 shown in FIGS. 9, 13, 14, 15 or 16 is the same as the configuration shown in FIG. 1 of the above-mentioned embodiment except for the points as described below. Specifically, as for a first modified example, the conductive film 3 may be formed so that it may have a laminated structure (three-layered structure) where a main conductive film 31 (311), a sub-conductive film 32, and another main conductive film 31 (312) are laminated in this order from the side near the substrate 1 for example, as shown in FIG. 9 which corresponds to FIG. 1. The main conductive films 311, 312 have the same configuration (function and material, etc.) as the main conductive film 31 explained in the above-mentioned embodiments except for the point that the films 311 and 312 have a thickness T11 and a thickness T12 (T11+T12=T1), respectively. In short, the main conductive films 311,312 have a tensile stress FT as internal stress F1. Incidentally, the sub-conductive film 32 (thickness T2) has a compressive stress FC as internal stress F2 as described above.

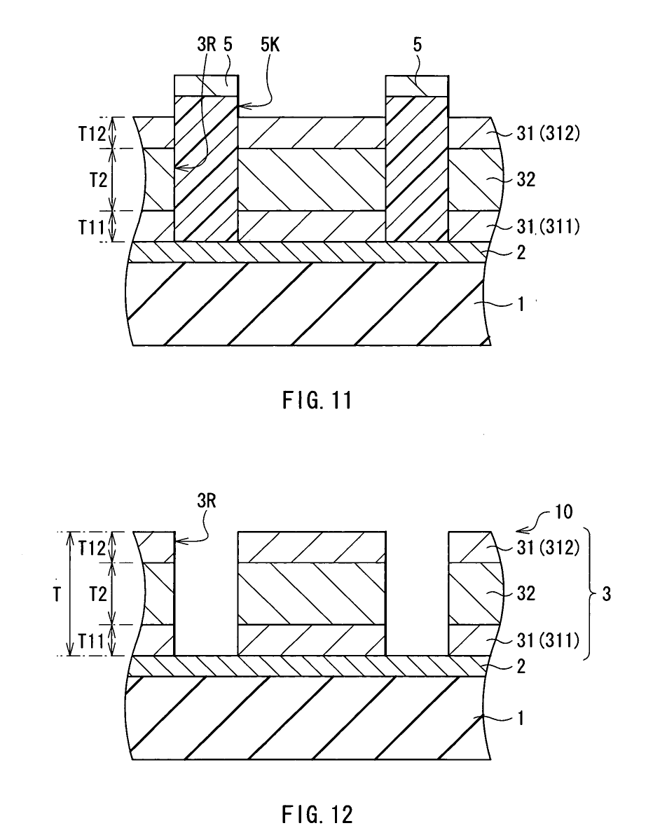

The composite substrate 10 provided with the conductive film 3 (main conductive film 311/sub-conductive film 32/main conductive film 312) can be fabricated by passing through the procedure shown in FIGS. 10-12. Namely, passing through the same procedure explained with reference to FIGS. 2 to 5 in the above-mentioned embodiments except for the point that the main conductive film 311 (thickness T11) is formed instead of the main conductive film 31 (thickness T1) and then the sub-conductive film 32 is formed on the main conductive film 311, the main conductive film 311 and the sub-conductive film 32 are formed on the substrate 1 in this order. Thereafter, as shown in FIG. 10, a photoresist pattern 5 is formed in a trench 3R first. In forming the photoresist pattern 5, it is to be noted that an opening 5K should be formed by passing through the same procedures as that of the photoresist pattern 4 explained in the above-mentioned embodiments. Then, the main conductive film 312 is formed as shown in FIG. 11 by growing up a plated film by electrolytic plating method whereby a seed film 2 with the main conductive film 311 and the sub-conductive film 32 are used as an electrode film. In this case, the main conductive film 312 is formed not only on the sub-conductive film 32 within the opening 5K of the photoresist pattern 5 but also on the photoresist pattern 5. Finally, by removing the photoresist pattern 5 as well as part of the main conductive film 312 (unwanted part) together, the conductive film 3 is formed so that it may have a laminated structure (three-layered structure) including the main conductive film 311, the sub-conductive film 32 and the main conductive film 312. In this case, a plurality of conductive films (main conductive film 311/sub-conductive film 32/main conductive film 312) are formed in a pattern shape separated by the trench 3R provided in the part where the photoresist pattern 5 was arranged. In this manner the composite substrate 10 is completed.

Also in this case, when the conductive film 3 is formed on the substrate 1, the conductive film 3 is formed including the main conductive films 311,312 which have a tensile stress FT as their internal stress F1 and the sub-conductive film 32 which has a compressive stress FC as its internal stress F2. Therefore, If the thickness T2 of the sub-conductive film 32 is set up to satisfy the relation of the above-described relational expression (4), the total tensile stress FT of the main conductive film 311,312 is offset by use of the compressive stress FC of the sub-conductive film 32. In this manner, deformation of the substrate 1 in response to the influence of the internal stress F of the conductive film 3 can be controlled in a similar way to the above-mentioned embodiments.

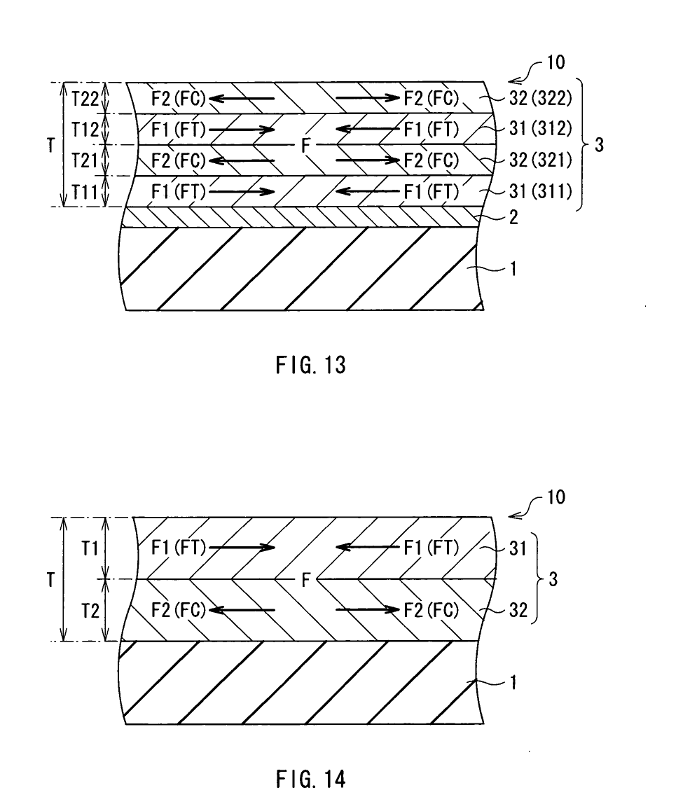

As for a second modified example, as shown in FIG. 13 corresponding to FIG. 1 for example, the conductive film 3 may be formed so that it may have a laminated structure where the main conductive film 31 and the sub-conductive film 32 are laminated repeatedly from the side near the substrate 1. The number of repeating lamination of this main conductive film 31 and the sub-conductive film 32, namely, the number of repeats of a lamination unit, one unit consisting of the main conductive film 31 and the sub-conductive film 32, can set up freely in one or more ranges. FIG. 13 is a case where the above-mentioned “number of repeating lamination” is set to 2, namely, the conductive film 3 is formed so that it may have a laminated structure (four-layered structure) where the main conductive film 31 (311), the sub-conductive film 32 (321), the main conductive film 31 (312), and the sub-conductive film 32 (322) are laminated in this order from the side near the substrate 1. The main conductive films 311,312 have the same configuration (function and material, etc.) as the main conductive film 31 explained in the above-mentioned embodiments except for the point of having a thickness T11 and a thickness T12 (T11+T12=T1) respectively. The sub-conductive films 321,322 have the same configurations (function and the material, etc.) with the sub-conductive film 32 as explained in the above-mentioned embodiments except for the point of having a thickness T21 and a thickness T22 (T21+T22=T2) respectively. Namely, both of the main conductive films 311,312 have a tensile stress FT as their internal stress F1 while both of the sub-conductive films 321,322 have a compressive stress FC as their internal stress F2.

Although here does not explain in detail with reference to the drawing, the composite substrate 10 which is provided with the conductive film 3 (main conductive film 311/sub-conductive film 321/main conductive film 312/sub-conductive film 322) shown in FIG. 13 can be fabricated by passing through the same procedure as explained with reference to FIGS. 2-5 in the above-mentioned embodiment except for the point that the main conductive film 311 (thickness T11), the sub-conductive film 321 (thickness T21), the main conductive film 312 (thickness T12) and the sub-conductive film 322 (thickness T22) are formed in this order instead of the main conductive film 31 (thickness T1) and the sub-conductive film 32 (thickness T2). Also in this case, when the conductive film 3 is formed on the substrate 1, the conductive film 3 is formed including the main conductive films 311,312 with a tensile stress FT as their internal stress F1 and the sub-conductive films 321,322 with a compressive stress FC as their internal stress F2. In this manner, deformation of the substrate 1 in response to the influence of the internal stress F of the conductive film 3 can be controlled in a similar way to the above-mentioned embodiment. Especially in this case, let the thickness T of the conductive film 3 (main conductive films 31/sub-conductive films 32) be set constant, the more the number of laminated structures of the conductive film 3 (the number of laminations of the main conductive film 31 and the number of laminations of the sub-conductive film 32) increases, the smaller the thickness of each layer becomes (that means the stress which remains in a layer becomes small). As a result of that, deformation produced between each layer also becomes small and then the internal stress F of the conductive film 3 can be stabilized.

As for a third modified example, as shown in FIG. 14 corresponding to FIG. 1 for example, the conductive film 3 may be formed so that it may have a laminated structure (two-layered structure) where the sub-conductive film 32 (thickness T2) and the main conductive film 31 (thickness T1) are laminated in this order from the side near the substrate 1.

Although here does not explain in detail with reference to the drawing, the composite substrate 10 provided with the conductive film 3 (sub-conductive film 32/main conductive film 31) shown in FIG. 14 can be fabricated by passing through the same procedure as that explained with reference to FIGS. 2-5 in the above-mentioned embodiments, except for the point that the main conductive film 31 is formed after forming the sub-conductive film 32. Also in this case, similar to the above-mentioned embodiment, deformation of substrate 1 in response to the influence of the internal stress F of the conductive film 3 can be controlled. Especially in this case, the sub-conductive film 32 provides a function as a seed film for growing up a plated film, and the main conductive film 31 can be formed by growing up a plated film using the sub-conductive film 32 as a seed film.

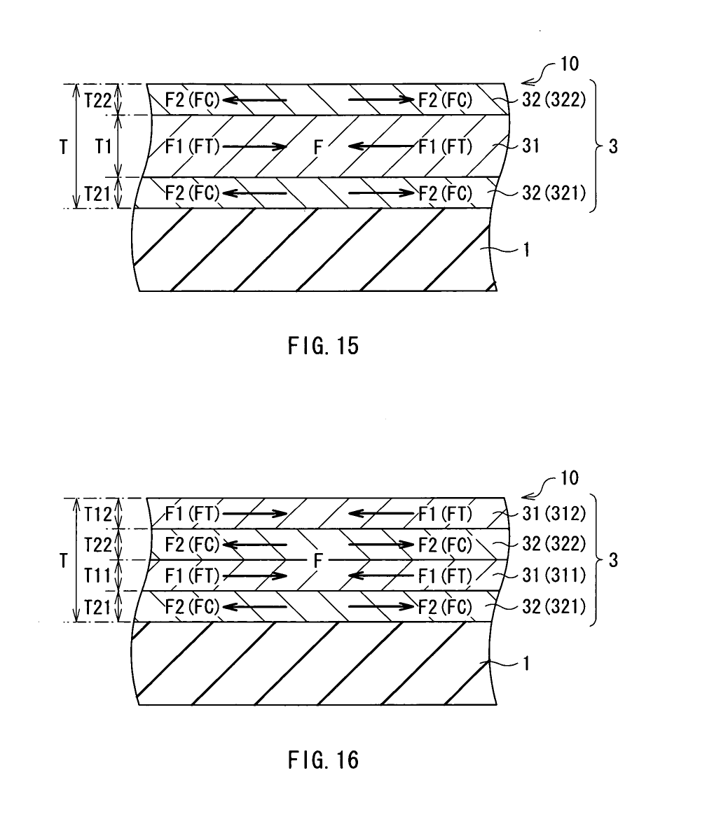

Therefore, unlike the case of the above-mentioned embodiment as shown in FIG. 1, the seed film 2 becomes unnecessary. Thereby, the configuration and manufacturing process of the composite substrate 10 can be simplified. This effect, that the configuration and manufacturing process of the composite substrate 10 are simplified, is also obtainable in the case of the composite substrate 10 shown in FIGS. 15 and 16.

As a fourth modified example, as shown in FIG. 15 corresponding to FIG. 1 for example, the conductive film 3 may be formed so that it may have a laminated structure (three-layered structure) where the sub-conductive film 32 (321), the main conductive film 31, and the sub-conductive film 32 (322) are laminated in this order from the side near the substrate 1. The sub-conductive films 321, 322 have the same configuration (function and material, etc.) as that of the sub-conductive film 32 explained in the above-mentioned embodiment except for the point that the sub-conductive films 321, 322 have a thickness T21 and a thickness T22 (T21+T22=T2) respectively. Accordingly, both of the sub-conductive films 321,322 have a compressive stress FC as their internal stress F2.

Although here does not explain in detail with reference to the drawing, the composite substrate 10 provided with the conductive film 3 (sub-conductive film 321/main conductive film 31/sub-conductive film 322) shown in FIG. 15 can be fabricated by passing through the same procedure explained with reference to FIGS. 2-5 in the above-mentioned embodiment except for the point that the sub-conductive film 321 (thickness T21), the main conductive film 31 (thickness T1), and the sub-conductive film 322 (thickness T22) are formed in this order instead of the main conductive film 31 (Thickness T1) and the sub-conductive film 32 (thickness T2). Also in this case, when the conductive film 3 is provided on the substrate 1, the conductive film 3 is formed including the main conductive film 31 which has a tensile stress FT as its internal stress F1 and sub-conductive films 321,322 which have a compressive stress FC as their internal stress F2. In this manner, deformation of the substrate 1 in response to the influence of the internal stress F of the conductive film 3 can be controlled in a similar way to the case of the above-mentioned embodiment.

As for a fifth modified example, as shown in FIG. 16 corresponding to FIG. 1 for example, the conductive film 3 may be formed so that it may have a laminated structure where the sub-conductive film 32 and the main conductive film 31 may be laminated in this order repeatedly from the side near the substrate 1. The number of repeating laminations of this sub-conductive film 32 and the main conductive film 31, namely, the number of repeats of a lamination unit, one unit consisting of the sub-conductive film 32 and the main conductive film 31, can be set up freely in the range of one or more. FIG. 16 shows a case where, for example, the above-described number of repeating laminations is set to 2, that is, the conductive film 3 is formed so that it may have a laminated structure (four-layered structure) where the sub-conductive film 32 (321), the main conductive film 31 (311), the sub-conductive film 32 (322), and then the main conductive film 31 (312) are formed in this order from the side near the substrate 1. The sub-conductive films 321,322 have the same configuration (function and materials, etc.) with the sub-conductive film 32 explained in the above-mentioned embodiment except for the point that the sub-conductive films 321, 322 have a thickness T21 and a thickness T22 (T21+T22=T2) respectively.

The main conductive films 311,312 have the same configuration (function and material, etc.) with that of the main conductive film 31 explained in the above-mentioned embodiment, except for the point of having a thickness T11 and a thickness T12 (T11+T12=T1). Namely, both of the sub-conductive film 321, 322 have a compressive stress FC as their internal stress F2, and both of the main conductive films 311,312 have a tensile stress FT as their internal stress F1.

Although here does not explain in detail with reference to the drawing, the composite substrate 10 provided with the conductive film 3 (sub-conductive film 321/main conductive film 311/sub-conductive film 322/main conductive film 312) shown in FIG. 16 can be fabricated by passing through the same procedure as explained with reference to FIGS. 2-5 in the above-mentioned embodiment, except for the point that the sub-conductive film 321 (thickness T21), the main conductive film 311 (thickness T11), the sub-conductive film 322 (thickness T22) and the main conductive film 312 (thickness T12) are formed in this order instead of the main conductive film 31 (thickness T1) and the sub-conductive film 32 (thickness T2). Also in this case, when the conductive film 3 is formed on the substrate 1, the conductive film 3 is formed to include the sub-conductive films 321,322 which have a compressive stress FC as their internal stress F2 and the main conductive films 311,312 which have a tensile stress FT as their internal stress F1. As a result, deformation of the substrate 1 in response to the influence of the internal stress F of the conductive film 3 can be controlled in a similar way to the case of the above-mentioned embodiment. Also in this case, as explained with reference to FIG. 13, the internal stress F of the conductive film 3 can be stabilized by increasing the number of the laminated structures of the conductive film 3 (the number of laminations of the main conductive film 31 and the number of laminations of the sub-conductive film 32).

With all the above, the description about the composite substrate and its manufacturing method concerning one embodiment of the present invention is ended.

Next will be explained a configuration of a thin film device to which the composite substrate of one embodiment of the present invention is applied. FIGS. 17 and 18 represent a configuration of a thin film inductor 20 as a thin film device, where the composite substrate 10 (refer to FIG. 1) explained in the above-mentioned embodiment is applied, and FIG. 17 shows a plane configuration and FIG. 18 shows a cross-sectional configuration taken on line XVIII-XVIII of FIG. 17.

A thin film inductor 20 has, as shown in FIGS. 17 and 18, a structure where a lower magnetic film 22, a top magnetic film 26, and a coil 25 arranged between the lower magnetic film 22 and the top magnetic film 26 are provided on the substrate 21. More specifically, the thin film inductor 20 has a structure where, for example, the lower magnetic film 22, the seed film 24 and the coil 25 buried in an insulating film 23 and the top magnetic film 26 are laminated in this order on the substrate 21.

The substrate 21, which corresponds to the substrate 1 in the composite substrate 10, supports the whole of the thin film inductor 20. This substrate 21 is made of an insulating material, such as silicon (Si), for example. Incidentally, the component material of the substrate 21 is not necessarily limited to the above-mentioned silicon, but can be freely selected within the range of the component materials applicable to the substrate 1 as explained in the above-mentioned embodiment.

The lower magnetic film 22 and the top magnetic film 26 have a function of raising the inductance of the thin film inductor 20. Each of these lower magnetic film 22 and the top magnetic film 26 is formed of any of the magnetic materials such as, for example, a cobalt (Co)-based alloy, an iron (Fe)-based alloy or a ferronickel alloy (NiFe; what is called a permalloy), etc. Among those, as for a cobalt-based alloy for example, a cobalt zirconium tantalum (CoZrTa)-based alloy or a cobalt zirconium niobium (CoZrNb)-based alloy is preferred from a practical point of view for using the thin film inductor 20.

The insulating film 23 works for electrically isolating the coil 25 from the circumference. The insulating film 23 is made of insulating materials, such as silicon Oxide (SiO₂) for example.

The seed film 24 is used for forming a part of the coil 25 (a main coil 251 which will be mentioned later), which corresponds to the seed film 2 in the composite substrate 10.

The coil 25 forms an inductor between one end (terminal 25M1) and the other end (25M2), which corresponds to the conductive film 3 in the composite substrates 10. This coil 25, which is made of conductive materials such as copper (Cu) for example, has a structure winding in a spiral way so that the terminal 25M1 and the other terminal 25M2 may be drawn outside. Especially, the coil 25 includes a main coil 251 (a first coil) having a tensile stress corresponding to the main conductive film 31 and a sub-coil 252 (a second coil) having a compressive stress corresponding to the sub-conductive film 32, and it has a laminated structure (two-layered structure) where, for example, the main coil 251 and the sub-coil 252 are laminated in this order from the side near the substrate 21. It is to be noted that the portion which leads to the terminal 25M2 of the coil 25 is arranged below a winding part which leads to the terminal 25M1 of the coil 25 so that it may be led outside without contacting the winding part which leads to the terminal 25M1 for example.

This thin film inductor 20 can be fabricated by passing through the following procedures for example. Namely, when manufacturing the thin film inductor 20, the lower magnetic film 22 is formed on the substrate 21 by electrolytic plating or by sputtering method first. Then, the insulating film 23 is formed on the lower magnetic film 22 by sputtering so that the seed film 24 and the coil 25 may be buried. In this case, for example, the seed film 24 and the coil 25 are formed in this order while the insulating film 23 is formed step-by-step in accordance with the fabrication progress of the seed film 24 and the coil 25. In this manner, the seed film 24 and the coil 25 have been buried in the insulating film 23. It is to be noted that the seed film 24 and the coil 25 (main coil 251, sub-coil 252) are formed using the fabrication method applied in the above-described manufacturing method of the composite substrate. Specifically, the formation practice used in fabricating the seed film 2 is used as the formation practice of the seed film 24. Besides, as a fabrication practice of the coil 25 (the main coil 251, the sub-coil 252), the formation practice of the conductive film 3 (the main conductive film 31, the sub-conductive film 32) is used.

Thereby, the main coil 251 comes to have a tensile stress as its internal stress while the sub-coil 252 comes to have a compressive stress as its internal stress. Finally, the top magnetic film 26 is formed on the insulating film 23 by electrolytic plating or by sputtering method, and the thin film inductor 20 shown in FIGS. 17 and 18 is completed.

In this thin film device or its manufacturing method, when the coil 25 is formed on the substrate 21, the coil 25 is formed so as to include a main coil 251 which has a tensile stress as its internal stress and a sub-coil 252 which has a compressive stress as its internal stress. Therefore, the tensile stress of the main coil 251 is offset by use of the compressive stress of the sub-coil 252 based on the same operation as explained in the above-mentioned composite substrate or its manufacturing method. In this manner, deformation of the substrate 21 in response to the influence of the internal stress of the coil 25 can be controlled.

Incidentally, in the present embodiment as shown in FIGS. 17 and 18, by applying the composite substrate 10 appearing in FIG. 1 to the thin film inductor 20, the coil 25 is formed so as to have a laminated structure (two-layered structure) where the main coil 251 and the sub-coil 252 are laminated in this order from the side near the substrate 21.

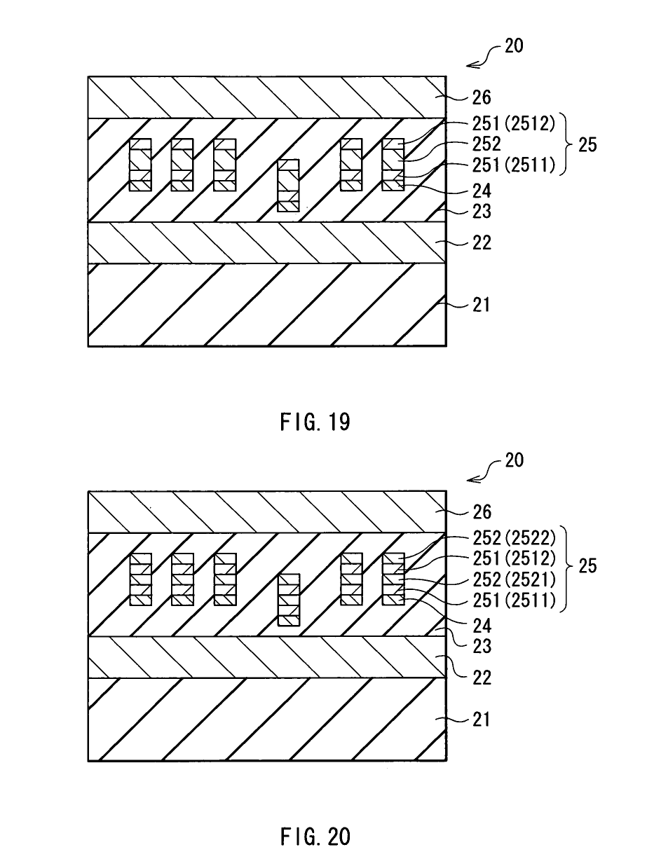

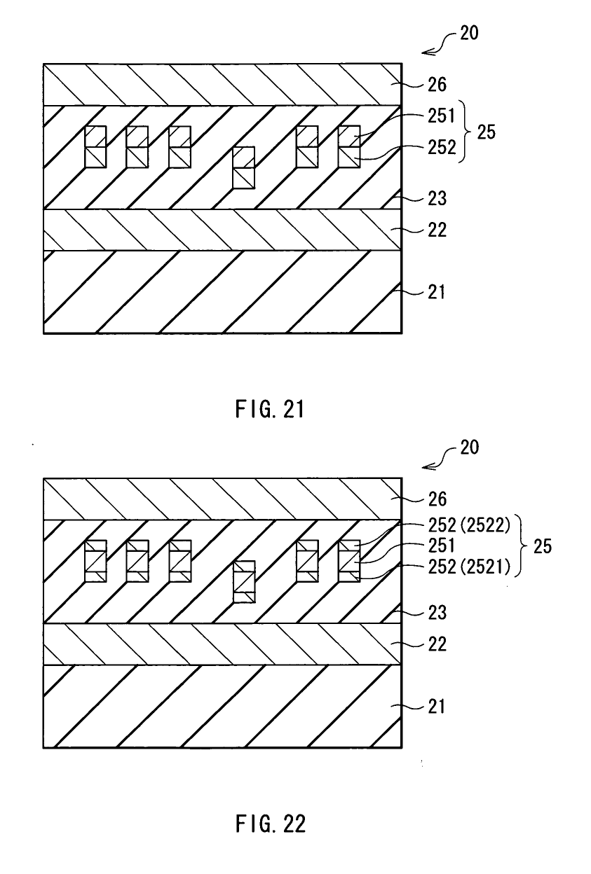

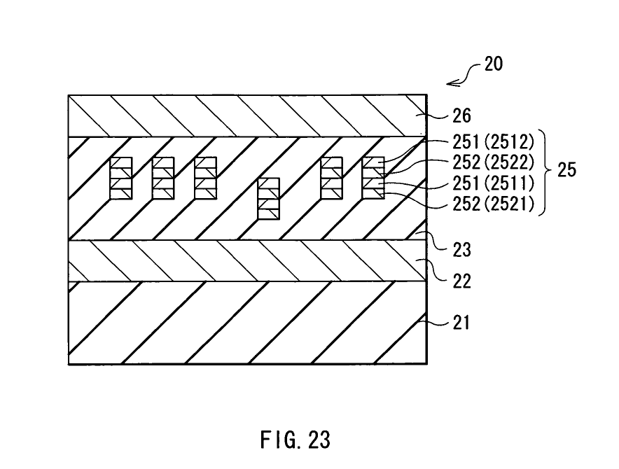

However, it is not necessarily limited to this. Specifically for example, as shown in FIGS. 19-23 corresponding to FIG. 18, the coil 25 may be formed by applying the composite substrate 10 in the series of modified examples explained with reference to FIG. 9 and FIGS. 13-16, to the thin film inductor 20. Namely, first, as shown in FIG. 19, by applying the composite substrate 10 shown in FIG. 9, the coil 25 can be formed to have a laminated structure (three-layered structure) where the main coil 251 (2511), a sub-coil 252 and another main coil 251 (2512) are laminated in this order from the side near the substrate 21. Second, as shown in FIG. 20, by applying the composite substrate 10 shown in FIG. 13, the coil 25 may be formed to have a laminated structure where the main coil 251 and the sub-coil 252 are laminated in this order repeatedly from the side near the substrate 21 (here is an example of a four-layered structure containing a main coil 2511, a sub-coil 2521, a main coil 2512, and a sub-coil 2522). Third, as shown in FIG. 21, by applying the composite substrate 10 shown in FIG. 14, the coil 25 may be formed to have a laminated structure (two-layered structure) where the sub-coil 252 and the main coil 251 are laminated in this order from the side near the substrate 21. Fourth, as shown in FIG. 22, by applying the composite substrate 10 shown in FIG. 15, the coil 25 may be formed to have a laminated structure (three-layered structure) where the sub-coil 252 (2521), the main coil 251 and the sub-coil 252 (2522) are laminated in this order from the side near the substrate 21. Fifth, as shown in FIG. 23, by applying the composite substrate 10 shown in FIG. 16, the coil 25 may be formed so as to have a laminated structure where the sub-coil 252 and the main coil 251 are laminated in this order repeatedly from the side near the substrate 21 (here is an example of a four-layered structure containing the sub-coil 2521, the main coil 2511, the sub-coil 2522 and the sub-coil 2512). In any of the above-mentioned cases, similarly to the case of the thin film inductor 20 shown in FIGS. 17 and 18, deformation of the substrate 21 in response to the influence of the internal stress of the coil 25 can be controlled. It is to be noted that the configuration of a series of the thin film inductor 20 shown in FIGS. 19-23 is the same as that shown in FIG. 18 except for the points described above.

Incidentally, since the configuration, procedure, operation, effect and deformation concerning the thin film device or its manufacturing method is the same as in the case of the above-mentioned composite substrate or its manufacturing method except for the points described above, the description on those is omitted herein.

As mentioned above, the present invention has been described with reference to the embodiments, but the present invention is not limited to the above-mentioned embodiments, and various modifications are obtainable. Specifically, for example, although a case is explained where the composite substrate of the present invention or its manufacturing method is applied to a thin film inductor as a thin film device or its manufacturing method in the above-mentioned embodiments, it is not necessarily limited to this, and can be applied to other thin film devices or their manufacturing methods other than the thin film inductor. Examples of this “other thin film devices” include, as described above, a thin film transformer, a thin film sensor, a thin film resistance, a thin film actuator, a thin film magnetic head, and MEMS. Even in the case of applying the composite substrate or its manufacturing method of the present invention to the above “other thin film devices” or their manufacturing method, an effect similar to the above-mentioned embodiments can be obtainable.

Besides, in the above-mentioned embodiments, a sputtering method is used as a practice for forming a sub-conductive film 32 so that it can have a compressive stress FC as its internal stress F2. However it is not necessarily limited to this, and other practices than the sputtering method may be used in order to form the sub-conductive film 32 as long as it may have a compressive stress FC as internal stress F2. Examples of the “other practices” include a vacuum deposition method and a chemical-vapor-deposition (CVD) method. Even if such an “other practice” is used for forming the sub-conductive film 32, an effect similar to the above-mentioned embodiments can be acquired.

The composite substrate or its manufacturing method of the present invention can be applied, for example to thin film devices including a thin film inductor, or their manufacturing methods.

What is claimed is:

1. A composite substrate comprising a conductive film having a laminated structure on a substrate, the laminated structure including a first conductive film with a tensile stress and a second conductive film with a compressive stress.

2. The composite substrate according to claim 1, wherein the first conductive film is a plated film, the second conductive film is a sputtered film.

3. The composite substrate according to claims 1, wherein the conductive film has a laminated structure in which the first conductive film and the second conductive film are laminated in this order from the side near the substrate.

4. The composite substrate according to claims 1, wherein the conductive film has a laminated structure in which the first conductive film, the second conductive film and the first conductive film are laminated in this order from the side near the substrate.

5. The composite substrate according to claims 1, wherein the conductive film has a laminated structure in which the first conductive film and the second conductive film are laminated in this order repeatedly from the side near the substrate.

6. The composite substrate according to claims 1, wherein the conductive film has a laminated structure in which the second conductive film and the first conductive film are laminated in this order from the side near the substrate.

7. The composite substrate according to claims 1, wherein the conductive film has a laminated structure in which the second conductive film, the first conductive film and the second conductive film are laminated in this order from the side near the substrate.

8. The composite substrate according to claims 1, wherein the conductive film has a laminated structure in which the second conductive film and the first conductive film are laminated in this order repeatedly from the side near the substrate.

9. A thin film device comprising on a substrate:
a first magnetic film;
a second magnetic film; and
a coil arranged between the first magnetic film and the second magnetic film,
the coil having a laminated structure including:
a first coil with a tensile stress; and
a second coil with a compressive stress.

10. A method of manufacturing a composite substrate comprising a substrate and a conductive film thereon having a laminated structure,
wherein a film formation process of the conductive film includes:
a film formation process of forming a first conductive film that composes a part of the conductive film with a tensile stress; and
a film formation process of forming a second conductive film that composes another part of the conductive film with a compressive stress.

11. The method of manufacturing the composite substrate according to claim 10, wherein the first conductive film is formed by electrolytic plating, and the second conductive film is formed by sputtering.

12. The method of manufacturing the composite substrate according to claim 11, wherein the second conductive film is formed by adjusting a gas-pressure of the sputtering gas so that it may obtain a compressive stress.

13. The method of manufacturing the composite substrate according to claims 11, wherein the second conductive film is formed so that the thickness of the second conductive film may satisfy the following relational expression:
T2≧X*D*T1/[Y*(PS−P)]
(where “T1” is a thickness of the first conductive film, “T2” is a thickness of the second conductive film, “D” is a current density in the film formation of the first conductive film using the electrolytic plating method,
“P” is a gas-pressure of the sputtering gas in the film formation of the second conductive film using the sputtering method,
“PS” is a pressure specified based on the type of a sputtering gas and the type of plating, the pressure used as the reference for producing a compressive stress inside the second conductive film (standard atmospheric pressure),
“X” is a constant specified based on the bath conditions of the plating bath to be used in the electrolytic plating method, and
“Y” is a constant specified based on the type of sputtering gas and the type of plating, respectively.)

14. A method of manufacturing a thin film device on a substrate, the thin film device comprising: a first magnetic film; a second magnetic film; and a coil having a laminated structure arranged between the first magnetic film and the second magnetic film,
wherein a fabrication process of the coil includes:
a fabrication process of a first coil that composes a part of the coil so that it may have a tensile stress; and
a fabrication process of a second coil that composes another part of the coil so that it may have a compressive stress.
